(19) United States
(12) Patent Application Publication
(10) Pub. No.: US 2026/0018683 A1
(43) Pub. Date: Jan. 15, 2026

(54) SENSOR FOR BATTERY ASSEMBLY, AND TESTING METHOD OF BATTERY ASSEMBLY USING THE SAME

(71) Applicant: SK On Co., Ltd., Seoul (KR)

(72) Inventor: Jang Wook PARK, Daejeon (KR)

(21) Appl. No.: 19/260,620

(22) Filed: Jul. 7, 2025

(30) Foreign Application Priority Data
Jul. 15, 2024 (KR) 10-2024-0092891

(51) Int. Cl. H01M 10/42; H01M 10/48; H01M 50/342

(52) U.S. Cl. CPC H01M 10/4228; H01M 10/425; H01M 10/48; H01M 50/342; H01M 2010/4278; H01M 2200/20

(57) ABSTRACT

The present disclosure relates to a sensor for a battery assembly and a testing method of a battery assembly using the same. A sensor for a battery assembly according to an embodiment of the present disclosure includes a body member having a first opening formed on one surface of the body member, the body member including an accommodation space accommodating at least a part of the battery assembly through the first opening, a sealing member disposed around the accommodation space, the sealing member coming in contact with the battery assembly when at least the part of the battery assembly is accommodated in the accommodation space, and a sensing member formed in the accommodation space and measuring environment data in the accommodation space.

### CROSS-REFERENCE TO RELATED PATENT APPLICATION

The present application claims priority under 35 U.S.C. § 119(a) to Korean patent application number 10-2024-0092891 filed on July 15, 2024 in the Korean Intellectual Property Office, the entire disclosure of which is incorporated by reference herein.

### BACKGROUND OF THE INVENTION

### Field

The present disclosure relates to a sensor for a battery assembly and a testing method of a battery assembly using the same, and more particularly, to a sensor fora battery assembly capable of quickly and accurately evaluating whether venting gas is generated in a battery cell in the battery assembly, and a testing method of the battery assembly using the sensor.

### Description of the Related Art

A battery module or a battery pack is a type of a battery assembly. The battery assembly may include a plurality of battery cells in an internal storage space.

When an electrical, thermal, or physical external stress is applied to a battery cell, such as when the battery cell is overcharged, deterioration may occur in the battery cell, and as a result, the temperature may rise, and venting gas may be generated for reasons such as electrolyte vaporization. As described above, whether the venting gas is generated can be an important measure for determining whether the quality of the battery cell is poor or whether the battery cell is deteriorated.

Lithium secondary batteries undergo various performance tests and safety tests such as life tests prior to release. During an evaluation process of performance and/or safety during the test, whether venting gas is generated in battery cells can be an important evaluation measure as described above.

However, in the conventional test process before release, whether venting gas is generated in a battery to be evaluated is very disadvantageous in terms of economic efficiency because the environment in which the evaluation is performed needs to be adjusted to a vacuum state. If the evaluation is not performed in the vacuum state, real-time venting gas generation cannot be evaluated, or even if it is possible, detection accuracy is very low.

### SUMMARY OF THE INVENTION

An aspect of the present disclosure is to provide a sensor for a battery assembly that has a simple structure and can quickly and accurately measure whether venting gas is generated in a battery to be evaluated.

Another aspect of the present disclosure is to provide a testing method of a battery assembly that can quickly and accurately measure whether venting gas is generated in a battery to be evaluated without adjusting evaluation environment to a vacuum state, and can easily adjust variables such as temperature while evaluating whether the venting gas is generated.

Meanwhile, the present disclosure may be widely applied in the fields of electric vehicles, battery charging stations, energy storage systems (ESS), and other green technologies such as photovoltaics and wind power using batteries. In addition, the present disclosure may be used in eco-friendly mobility, including electric vehicles and hybrid vehicles, to prevent climate change by suppressing air pollution and greenhouse fluid emissions.

A sensor for a battery assembly according to embodiments of the present disclosure may include a body member having a first opening formed on one surface of the body member, the body member including an accommodation space accommodating at least a part of the battery assembly through the first opening, a sealing member disposed around the accommodation space, the sealing member coming in contact with the battery assembly when at least the part of the battery assembly is accommodated in the accommodation space, and a sensing member formed in the accommodation space and measuring environment data in the accommodation space.

The body member and the sealing member may include materials having different hardnesses.

The body member may include a hard material.

The body member may include a transparent material.

The sealing member may include a soft material.

The body member and the sealing member include a material through which air or water does not permeate.

The sensor for the battery assembly may further include a monitoring module electrically connected to the sensing member and monitoring the environment data measured from the sensing member.

The sensor for the battery assembly may further include a connection line electrically connecting the sensing member and the monitoring module, and the connection line may include a first connection line having a variable position and a second connection line having a fixed position, and at least one end of the first connection line is connected to the sensing member.

The sensor for the battery assembly may further include a controller module electrically connected to the monitoring module, controlling the sensing member, and collecting and storing the environment data.

The body member may be formed such that the accommodation space further includes an opening on at least one other surface perpendicular to the one surface.

A testing method of a battery assembly including a plurality of battery cells, a housing accommodating the plurality of battery cells, and a venting hole formed in at least a part of the housing by using a sensor for the battery assembly, the sensor for the battery assembly comprising: a body member having a first opening formed on one surface of the body member, the body member including an accommodation space accommodating at least a portion of the battery assembly through the first opening, a sealing member disposed around the accommodation space, the sealing member coming in contact with the battery assembly when at least a part of the battery assembly is accommodated in the accommodation space, and a sensing member formed in the accommodation space and measuring environment data in the accommodation space according to embodiments of the present disclosure may include accommodating at least the part of the battery assembly in the accommodation space, and testing the battery assembly accommodated in the accommodation space by measuring or evaluating the environment data of the accommodation space.

The accommodating may include accommodating at least the part of the battery assembly such that the venting hole is located in the accommodation space.

The accommodating may include accommodating at least the part of the battery assembly so that the accommodation space is sealed from an outside.

The environment data may include presence or amount of venting gas discharged from the venting hole.

The testing method may further include collecting and storing data measured or evaluated by the testing.

### BRIEF DESCRIPTION OF THE DRAWINGS

FIG. 1 is an exploded view illustrating a sensor for a battery assembly according to an embodiment of the present disclosure.

FIG. 2 is a diagram illustrating a coupling state between components of a sensor for a battery assembly according to an embodiment of the present disclosure.

FIG. 3 is a diagram illustrating an internal structure of a sensor for a battery assembly and an electrical connection relationship between components according to an embodiment of the present disclosure.

FIG. 4 is an exploded view illustrating a sensor for a battery assembly according to another embodiment of the present disclosure.

FIG. 5 is a diagram illustrating a coupling state between components of a sensor for a battery assembly according to another embodiment of the present disclosure.

FIG. 6 is an exploded view illustrating a sensor for a battery assembly according to another embodiment of the present disclosure.

FIG. 7 is a diagram illustrating a coupling state between components of a sensor for a battery assembly according to another embodiment of the present disclosure.

FIG. 8 is an exploded view showing an example of a battery assembly to be tested.

FIG. 9 is a diagram showing a combined state of the battery assembly of FIG. 8.

FIG. 10 is a cross-sectional view taken along line A-A' of FIG. 9.

FIG. 11 is an exploded view illustrating a sensor for a battery assembly and a battery assembly to be tested according to an embodiment of the present disclosure.

FIG. 12 is a diagram illustrating a state in which at least a part of a battery assembly is accommodated in a sensor for a battery assembly according to an embodiment of the present disclosure.

FIG. 13 is a diagram showing an inside of a battery assembly accommodated in an accommodation space of a sensor for a battery assembly according to an embodiment of the present disclosure.

FIG. 14 is an exploded view illustrating a sensor for a battery assembly and a battery assembly to be tested according to another embodiment of the present disclosure.

FIG. 15 is a diagram illustrating a state in which at least a part of a battery assembly is accommodated in a sensor for a battery assembly according to another embodiment of the present disclosure.

FIG. 16 is an exploded view illustrating a sensor for a battery assembly and a battery assembly to be tested according to another embodiment of the present disclosure.

FIG. 17 is a diagram illustrating a state in which at least a part of a battery assembly is accommodated in a sensor for a battery assembly according to another embodiment of the present disclosure.

### DETAILED DESCRIPTION

Hereinafter, the present invention will be described in detail with reference to the accompanying drawing. However, those skilled in the art will appreciate that such embodiments described with reference to the accompanying drawing are provided to further understand the spirit of the present invention and do not limit subject matters to be protected as disclosed in the detailed description and appended claims. Furthermore, throughout the disclosure, unless otherwise particularly stated, the word "comprise", "include", "contain", or "have" does not mean the exclusion of any other constituent element, but means further inclusion of other constituent elements, and elements, materials, or processes which are not further listed are not excluded.

Being equal or uniform in this specification may mean being equal or uniform to each other within an acceptable margin of error unless otherwise specified. For example, the fact that certain components or physical property measurement values are the same may include the meaning that the two objects to be compared are not only completely the same, but also the same within the error range. On the other hand, the fact that certain physical property measurement values are the same may mean that the difference in measurement values between objects is approximately less than 5%, specifically less than 3%, and more specifically less than 1%.

In this specification, that the angles formed by the two objects are perpendicular or parallel or parallel to each other may include not only being geometrically perpendicular or parallel, but also being within a slight error range.

The numerical range used in the present disclosure comprises all values within the range comprising the lower limit and the upper limit, increments logically derived in a form and spanning in a defined range, all double limited values, and all possible combinations of the upper limit and the lower limit in the numerical range defined in different forms.

Unless otherwise defined herein, "about" may be considered a value within 30%, 25%, 20%, 15%, 10%, or 5% of the stated value.

In this specification, "electrically connected" may mean, without limitation, any connection method by which a plurality of objects may be connected to each other so as to be in electrical communication with each other.

A configuration defined herein as a "part" or a "module" may mean a unit that processes at least one function or operation, and may be implemented in hardware or software, or a combination of hardware and software.

As used herein, "arranged" may mean, without limitation, a positional relationship by which one object may be positioned adjacent to another object. By way of a non-limiting example, it may mean coating one object with another object, adhering one object to another object via an adhesive material, fusing one object to another by applying heat, pressure, or the like, or simply positioning at least a portion of one object within any space to abut at least a portion of another object.

In the present specification, the term "face each other" may mean that objects each including at least one plane are positioned adjacently or non-adjacently with each plane kept parallel.

In this specification, the "X direction", the "Y direction", and the "Z direction" may optionally refer to any one of directions constituting an orthogonal coordinate system with X, Y, and Z axes perpendicular to each other in a three-dimensional space.

As used herein, the term "lithium secondary battery" may refer to a battery that generates electrical energy by oxidation and reduction reactions when lithium ions are inserted and extracted in and from a cathode and an anode.

As used herein, the term "battery cell" may refer to a basic unit of a lithium secondary battery capable of charging and discharging electrical energy.

Hereinafter, the present disclosure will be described in detail. This is, however, illustrative only and not intended to limit the disclosure to the specific embodiments illustratively described.

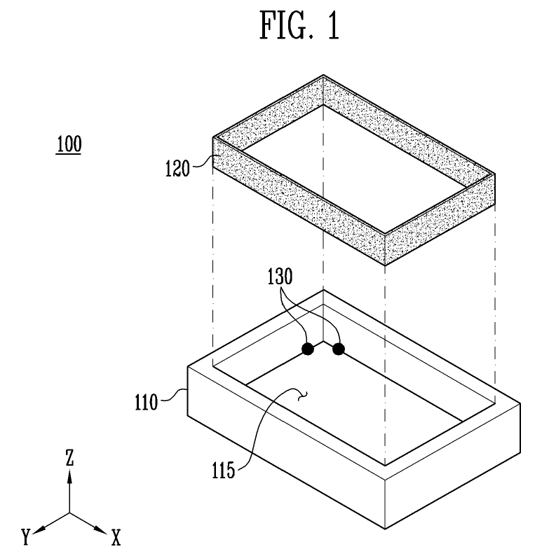

FIG. 1 is an exploded view illustrating a sensor 100 for a battery assembly according to an embodiment of the present disclosure.

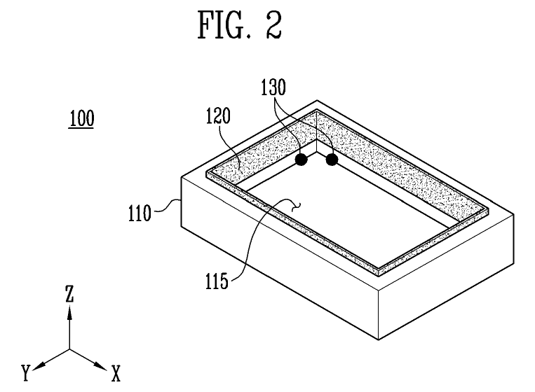

FIG. 2 is a diagram illustrating a coupling state between components of the sensor 100 for the battery assembly according to an embodiment of the present disclosure.

The sensor 100 for the battery assembly according to an embodiment of the present disclosure may include: a body member 110 including an accommodation space 115 having a first opening formed on one surface thereof and accommodating at least a part of a battery assembly 200 through the first opening; a sealing member 120 disposed around the accommodation space 115 in which the sealing member 120 contacts the battery assembly 200 when at least a part of the battery assembly 200 is accommodated in the accommodation space 115; and a sensing member 130 formed in the accommodation space 115 and measuring environment data in the accommodation space 115..

Referring to FIGS. 1 and 2, in an embodiment, the body member 110 may include the accommodation space 115 which has the first opening formed on one surface thereof and communicates with the outside through the first opening.

By way of an example as shown in FIGS. 1 and 2, the accommodation space 115 may refer to a space formed on one surface of the body member 110 on which the first opening is formed. That is, as shown in FIG. 1, the first opening is formed so as to communicate with the outside only in one direction of a Z direction, and the space is sealed from the outside by the body member 110 in the other directions. Referring to FIG. 1, in an exemplary embodiment, the accommodation space 115 may mean a rectangular parallelepiped-shaped space in which one surface communicates with the outside and the other surfaces are sealed by the body member 110. However, this is merely an example, and the accommodation space 115 may have various shapes without departing from the scope defined in the present disclosure.

As will be described below, the accommodation space 115 may have a shape corresponding to at least a portion of the battery assembly 200 so that an object to be tested, that is, at least the portion of the battery assembly 200 according to the present disclosure may be sealed and accommodated. As in the above-described embodiment of the present disclosure, when the accommodation space 115 has a shape in which the first opening is formed on the one surface thereof, the entire surface of one face of the battery assembly 200 may be covered by the body member 110. More specifically, the battery assembly 200 may be fitted and coupled to the accommodation space 115 of the body member 110 so that the entire surface of one face of the battery assembly 200 may be completely covered. The accommodation space 115 of the body member 110 may have a shape corresponding to the entire surface of one face of the battery assembly 200.

In the present disclosure, when a shape of one object "corresponds to" that of another object," it means that one object and another object have only a slight difference in shape and area to the extent that the objects may be fitted and coupled to each other.

Referring to FIGS. 1 and 2, in an embodiment, the sensor 100 for the battery assembly may include the sealing member 120 disposed around the accommodation space 115 of the body member 110.

By way of the example as shown in FIGS. 1 and 2, as described above, the accommodation space 115 may have a shape in which the first opening is formed on the one surface thereof, and remaining portions other than the first opening are sealed by the body member 110. In addition, as described above, the accommodation space 115 may provide a space in which at least a part of the battery assembly 200 is sealed from the outside and accommodated.

In an embodiment, when at least a part of the battery assembly 200 is coupled to and accommodated in the accommodation space 115, the sealing member 120 may serve to seal the coupled part to ensure the airtightness of the accommodation space 115 in the coupled area. In this regard, the sealing member 120 may be disposed around the accommodation space 115 so as to maintain the airtightness of the accommodation space 115 in the coupled area when the battery assembly 200 is coupled to the accommodation space 115. The sealing member 120 may come in contact with the battery assembly 200 and function to seal the coupled part.

By way of the example as shown in FIGS. 1 and 2, the sealing member 120 may be disposed to contact inner circumferential surfaces of all surfaces of the accommodation space 115, except for another surface parallel to the one surface of the accommodation space 115 where the first opening is formed. As will be described below, when at least a part of the battery assembly 200 is coupled to and accommodated in the accommodation space 115, the inner circumferential surface may be a region in which at least a part of the battery assembly 200 and the body member 110 are in direct contact with each other, and as a result, the sealing member 120 may be disposed in the corresponding region to ensure the airtightness of the accommodation space 115. The inner circumferential surface may mean an area or a surface of the body member 110 which is in contact with the accommodation space 115.

Referring to FIGS. 1 and 2, in an embodiment, the sealing member 120 may correspond to the accommodation space 115.

In an embodiment, the sealing member 120 may be disposed around the accommodation space 115 and coupled to the body member 110 by using a bolt or a magnet to thereby be fixed around the accommodation space 105.

In an embodiment, the sensing member 130 may be formed in the accommodation space 115 and measure environment data in the accommodation space 115.

In one embodiment, the environment data may refer to temperature, humidity, presence or amount of a particular gas or other particular substances in the accommodation space 115. In a specific embodiment, the environment data may refer to the presence or absence or amount of a specific gas. In a more specific embodiment, the environment data may refer to the presence or amount of venting gas which may be generated in the battery cell 250 which will be described below.

In an embodiment, the sensing member 130 may include a conventional temperature sensor, a conventional humidity sensor, or a conventional gas sensor. In a specific embodiment, the sensing member 130 may include a conventional gas sensor. In a more specific embodiment, the sensing member 130 may include, without limitation, a conventional gas sensor capable of measuring venting gas which may be generated in the battery cell 250. For example, the venting gas may include carbon monoxide, carbon dioxide, methane, ethane, benzene, ethylene, and the like. As the sensing member, conventional gas sensors capable of sensing gases including the gas components as described above are applicable without limitation.

In an embodiment, the sensing member 130 may be formed in the accommodation space 115.

Unlike FIGS. 1 and 2, the number of sensing members 130 and the shape thereof may not be particularly limited as long as the sensing member 130 is formed in the accommodation space 115. The sensing member 130 may be formed at a position farthest from the first opening in the accommodation space 115, but is not necessarily limited thereto.

In an embodiment, the body member 110 and the sealing member 120 may include materials having different hardnesses. In a specific embodiment, the body member 110 may include a harder material, and the sealing member 120 may include a flexible material.

In an embodiment, the body member 110 may include a hard material. In a specific embodiment, the body member 110 may include a rigid material. In a specific embodiment, the body member 110 may include, without limitation, a rigid polymer, a rigid plastic, or a metal material.

In an embodiment, the body member 110 may include a transparent material. In this regard, the body member 110 may be made of a rigid and transparent material. As a specific example, a transparent acrylic material may be used as the material of the body member 110, but the present disclosure is not necessarily limited thereto. When the body member 110 includes a rigid and transparent material, the shape of the sensor 100 for the battery assembly may be maintained, and at the same time, it may be more advantageous in terms of manufacturing fairness of a sensor such as processing, and may be more preferable in terms of maintenance.

In an embodiment, the sealing member 120 may include a soft material. In a specific embodiment, the sealing member 120 may include a flexible material. In a specific embodiment, the sealing member 120 may include, without limitation, a thermoplastic polymer, soft plastic, or rubber material. Since the sealing member 120 includes a flexible material, the sealing member 120 may be easily deformed to fit the shape of the battery assembly 200 made of a generally rigid material or the shape of the body member 110 made of the rigid material as described above. As a result, when at least a part of the battery assembly 200 is accommodated in the accommodation space, the coupled area may be sealed more smoothly.

In an embodiment, the body member 110 and the sealing member 120 may include a material which does not transmit air or water. As will be described below, when at least a part of the battery assembly 200 is accommodated in the accommodation space 115, the accommodation space 115 may form a sealed area between the body member 110 and the battery assembly 200 in which the inflow of air or moisture from the outside is blocked. In order to form the sealed region, the body member 110 and the sealing member 120 may include a material which does not allow air or water to pass therethrough. As a specific example thereof, the above-described materials may be applied without limitation to the extent that those materials have the property of not permeating air or water.

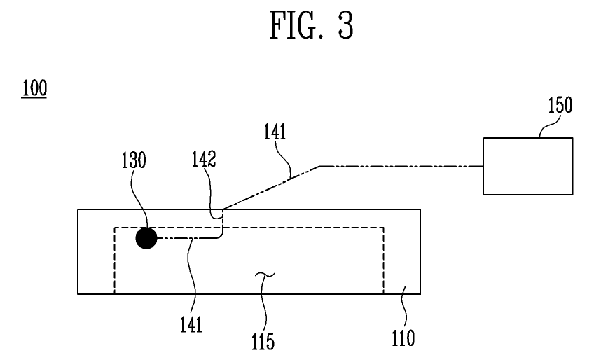

FIG. 3 is a diagram illustrating an internal structure of the sensor 100 for the battery assembly and an electrical connection relationship between components according to an embodiment of the present disclosure.

In an embodiment, the sensor 100 for the battery assembly may further include a monitoring module 150 electrically connected to the sensing member 130 to monitor the environment data measured from the sensing member 130.

In an embodiment, the monitoring module 150 may monitor the environment data measured from the sensing member 130. Accordingly, the monitoring module 150 may receive the environment data measured in real time or at regular time intervals from the sensing member 130, and may display the environment data visually and/or audibly through a separate display unit. The monitoring module 150 may include visual and/or audible display unit such as a monitor and a speaker, and details thereof are not particularly limited to the extent that the above-described purpose can be achieved.

In an embodiment, the sensor 100 for the battery assembly may further include a connection line 140 electrically connecting the sensing member 130 and the monitoring module 150, and the connection line 140 may include a first connection line 141 having a variable position and a second connection line 142 having a fixed position. At least one end of the first connection line 142 may be connected to the sensing member 130.

In an embodiment, the connection line 140 may electrically connect the sensing member 130 and the monitoring module 150. One end of the connection line 140 is electrically connected to the sensing member 130, and the other end thereof is electrically connected to the monitoring module 150, so that the sensing member 130 and the monitoring module 150 may be electrically connected.

Referring to FIG. 3, in an embodiment, the connection line 140 includes the first connection line 141 having the variable position and the second connection line 142 having the fixed position, and at least one end of the first connection line 142 may be connected to the sensing member 130.

In an embodiment, the sensing member 130 may be fixed in the accommodation space 115 of the body member 110. However, the position of the sensing member 130 may be appropriately adjusted in the accommodation space 115. The connection line 140 directly connected to the sensing member 130 may be the first connection line 141 having the variable position.

In an embodiment, one end of the second connection line 142 may be connected to the other end of the first connection line 141 directly connected to the sensing member 130, and may be formed as a path passing through the body member 110. As described above, the body member 110 does not transmit air or water from the outside, so that when at least a part of the battery assembly 200 to be tested is accommodated in the accommodation space 115, it is necessary to ensure the airtightness of the space between the battery assembly 200 and the body member 110.

The connection line 140 for transmitting the environment data measured from the sensing member 130 to the monitoring module 150 does not extend toward the opening of the accommodation space 115 in order to ensure the airtightness in the accommodation space 115 as described above. The connection line 140 may extend in a direction toward the outside from the accommodation space 115 of the body member 110 by forming the path through the body member 110. Since it also is necessary to ensure the airtightness of the region where the connection line 140 passes through the body member 110, the connection line 140 having the path passing through the body member 100 may be the second connection line 142 with the fixed position.

In an embodiment, in order to fix the position of the second connection line 142 and still ensure the airtightness of the accommodation space 115 in the body member 110, a material which does not allow air or water to pass through the region through which the second connection line 242 passes may be introduced to seal the region, thereby sealing the corresponding region.

Referring to FIG. 3, in an embodiment, one end of the second connection line 142 from the accommodation space 115 to the outside of the body member 110 may be connected to another first connection line 141. The other end of the first connection line 141 may be connected to the monitoring module 150.

In an embodiment, the sensor 100 for the battery assembly may further include a controller module (not shown) electrically connected to the monitoring module 150 to control the sensing member 130 and collect and store the environment data. The above controller module (not shown) may be employed without limitation as long as the controller module corresponds to a known means capable of receiving and collecting, storing or analyzing electrical signals. As an example of such a means, the controller module (not shown) may include, but is not limited to, a processor, a networking device, a memory, and the like.

In an embodiment, the controller module (not shown) may be electrically connected to the monitoring module 150. In an embodiment, the controller module (not shown) may be connected to the monitoring module 150 in a wired or wireless manner. The controller module (not shown) may be electrically connected to the sensing member 130 via the monitoring module 150, or may be directly connected to and controlled by the sensing member 130 without passing through the monitoring module 150.

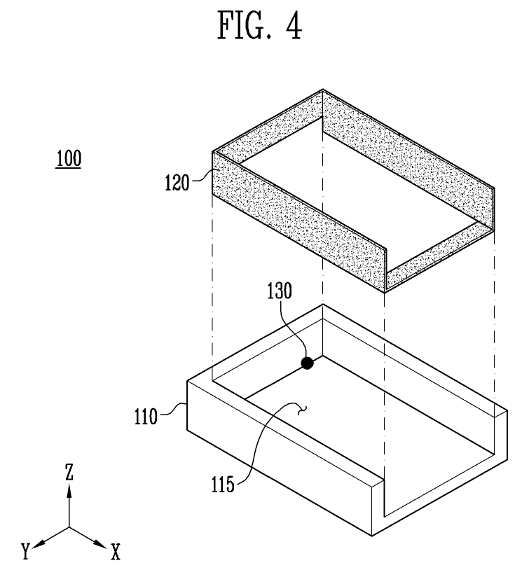

FIG. 4 is an exploded view illustrating the sensor 100 for the battery assembly according to another embodiment of the present disclosure.

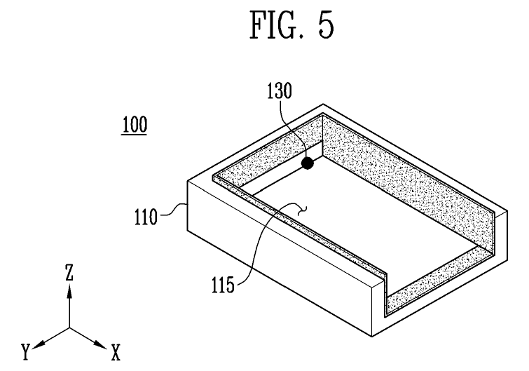

FIG. 5 is a diagram illustrating a coupling state between components of the sensor 100 for the battery assembly according to another embodiment of the present disclosure.

In an embodiment, the body member 110 may be formed such that the accommodation space 115 further includes an opening on at least one other surface perpendicular to the one surface.

FIGS. 4 and 5 are diagrams illustrating the sensor 100 for the battery assembly according to another embodiment of the present disclosure.

Referring to FIGS. 4 and 5, the body member 110 may be formed such that the accommodation space 115 further includes a second opening on one other surface perpendicular to the one surface in addition to the first opening formed on the one surface as described above. That is, as shown in FIG. 4, the first opening may be formed so as to communicate with the outside in one direction of the Z direction, and at the same time, the second opening may be provided so as to communicate with the outside in the one direction of the X direction, and in the other directions except for the first and second openings, the space is sealed from the outside by the body member 110. Referring to FIG. 4, in an exemplary embodiment, the accommodation space 115 may mean a rectangular parallelepiped-shaped space in which one surface and the other surface on which the first opening and the second opening are formed communicate with the outside, and the remaining surfaces are sealed by the body member 110. However, this is merely an example, and the accommodation space 115 may have various shapes without departing from the scope defined in the present disclosure.

As will be described below, the accommodation space 115 may have a shape corresponding to at least a portion of the battery assembly 200 so that an object to be tested, that is, at least the portion of the battery assembly 200 according to the present disclosure may be sealed and accommodated. As another embodiment of the present disclosure described above, when the accommodation space 115 has a shape in which the first opening is formed on one surface and the second opening is formed on another surface perpendicular to the one surface, one surface of the battery assembly 200 may be partially covered by the body member 110. For example, an area adjacent to the edge of the battery assembly 200 may be covered so as to include the entire surface extending in the extension direction of the edge. The accommodation space 115 of the body member 110 may have a shape corresponding to one edge of the battery assembly 200.

In an embodiment, the sealing member 120 disposed around the accommodation space of the body member 110 may be formed such that a region of the sealing member 150 abutting the second opening may be parallel to the one surface.

By way of the example as shown in FIGS. 4 and 5, as described above, the accommodation space 115 may have a shape in which the first opening is formed on one surface thereof, the second opening is formed on another surface perpendicular to the one surface, and remaining portions other than the first and second openings are sealed by the body member 110. In addition, as described above, the accommodation space 115 may provide a space in which at least a part of the battery assembly 200 is sealed and accommodated from the outside.

In an embodiment, when at least a part of the battery assembly 200 is coupled to and accommodated in the accommodation space 115, the sealing member 120 may seal the coupled part to ensure the airtightness of the accommodation space 115 in the coupled area. In this regard, the sealing member 120 may be disposed around the accommodation space 115 so as to maintain the airtightness of the accommodation space 115 in the coupled area when the battery assembly 200 is coupled to the accommodation space 115.

By way of the example as shown in FIGS. 4 and 5, the sealing member 120 may be disposed so as to be in contact with all of the inner circumferential surfaces of the body member 110 in contact with the accommodation space 115. In an embodiment, the sealing member 120 may be formed such that a region of the accommodation space 115 in contact with another surface parallel to the one surface on which the first opening is formed and regions in contact with surfaces other than another surface may be perpendicular to each other. That is, as shown in FIG. 4, in the accommodation space 115, the region in contact with the other surface parallel to the one surface on which the first opening is formed may be parallel to an XY plane, and the remaining regions except the above region may be parallel to a YZ plane or an XZ plane. In this manner, when the body member 110 of the sensor 100 for the battery assembly according to another embodiment of the present disclosure having the above-described aspect and at least a part of the battery assembly 200 are coupled to each other, the airtightness of the accommodation space 115 may be secured from the outside.

Referring again to FIGS. 4 and 5, in an embodiment, the sealing member 120 may correspond to the accommodation space 115.

In addition, the descriptions of the material of the body member 110 and/or the sealing member 120, the sensing member 130, the monitoring module 150, the connection line 140, and the controller module (not shown) as described with reference to FIGS. 1 to 3 may be applied without limitation.

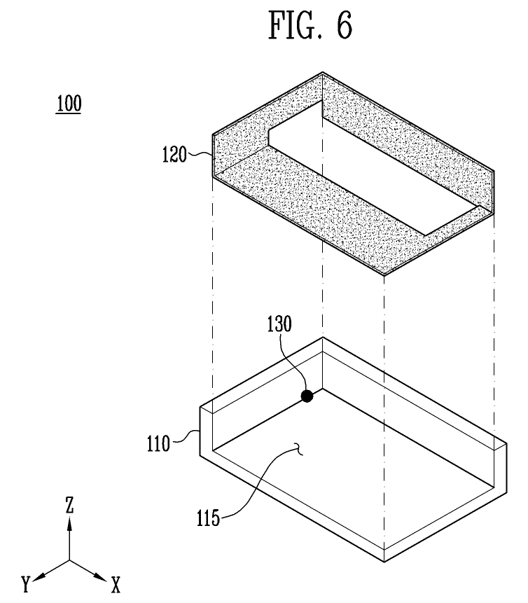

FIG. 6 is an exploded view illustrating the sensor 100 for the battery assembly according to another embodiment of the present disclosure.

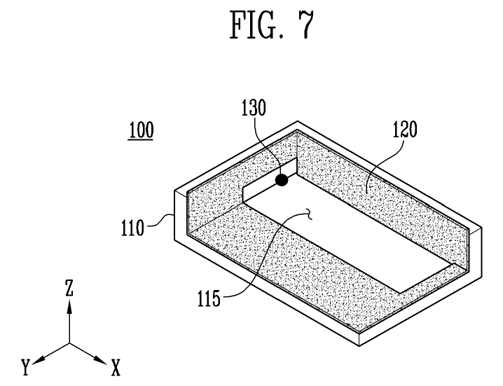

FIG. 7 is a diagram illustrating a coupling state between components of the sensor 100 for the battery assembly according to another embodiment of the present disclosure.

FIGS. 6 and 7 are diagrams illustrating the sensor 100 for the battery assembly according to another embodiment of the present disclosure.

Referring to FIGS. 6 and 7, the body member 110 may be formed such that the accommodation space 115 includes, in addition to the first opening formed on the one surface as described above, a second opening on another surface perpendicular to the one surface, and may further include a third opening on another surface perpendicular to both surfaces. That is, as shown in FIG. 6, the first opening is formed so as to communicate with the outside in one direction of the Z direction, and at the same time, the second opening is formed to communicate with the outside in one direction of the Y direction, the third opening is formed in one direction of the X direction so as to communicate with the outside, and the space is sealed by the body member 110 in the other directions except for the first opening, the second opening, and the third opening. Referring to FIG. 6, in an exemplary embodiment, the accommodation space 115 may refer to a space in which one surface, another surface, and another surface perpendicular to both surfaces on which the first opening, the second opening, and the third opening are formed communicate with the outside, and the remaining surfaces are sealed by the body member. However, this is merely an example, and the accommodation space 115 may have various shapes without departing from the scope defined in the present disclosure.

As will be described below, the accommodation space 115 may have a shape corresponding to at least a portion of the battery assembly 200 so that the object to be tested, that is, at least the portion of the battery assembly 200 according to the present disclosure may be is sealed and accommodated. As another embodiment of the present disclosure described above, when the accommodation space 115 has a shape in which a first opening is formed on one surface, a second opening is formed on another surface perpendicular to the one surface, and a third opening is formed on another surface perpendicular to both surfaces, one surface of the battery assembly 200 may be partially covered by the body member 110, and for example, may be covered so as to include a region adjacent to a vertex of the battery assembly 200. The accommodation space 115 of the body member 110 may have a shape corresponding to one vertex of the battery assembly 200.

In an embodiment, the sealing member 120 disposed around the accommodation space of the body member 110 may be formed such that regions of the sealing member 150 abutting the second opening and the third opening may be parallel to the one surface.

By way of the example as shown in FIGS. 6 and 7s, as described above, the accommodation space 115 may have a shape in which the first opening is formed on the one surface, the second opening is formed on another surface perpendicular to the one surface, the third opening is formed on another surface perpendicular to both surfaces, and the other portions of the accommodation space 115 except the first, second, and third openings are sealed by the body member 110. In addition, as described above, the accommodation space 115 may provide a space in which at least a part of the battery assembly 200 is sealed and accommodated from the outside.

In an embodiment, when at least a part of the battery assembly 200 is coupled to and accommodated in the accommodation space 115, the sealing member 120 may seal the coupled part to ensure the airtightness of the accommodation space 115 in the coupled area. In this regard, the sealing member 120 may be disposed around the accommodation space 115 so as to maintain the airtightness of the accommodation space 115 in the coupled area when the battery assembly 200 is coupled to the accommodation space 115.

By way of the example as shown in FIGS. 6 and 7, the sealing member 120 may be disposed so as to be in contact with all of the inner circumferential surfaces of the body member 110 in contact with the accommodation space 115. In an embodiment, the sealing member 120 may be formed such that a region in contact with another surface parallel to the one surface on which the first opening is formed in the accommodation space 115 and regions in contact with surfaces other than another surface are all perpendicular to each other. That is, as shown in FIG. 6, in the accommodation space 115, the region in contact with the other surface parallel to the one surface on which the first opening is formed may be parallel to an XY plane, and the remaining regions except the above region may be parallel to an YZ plane or an XZ plane.

The region in contact with another surface parallel to the one surface on which the first opening is formed may be formed on the same plane, and the region extending in the X direction and the region extending in the Y direction along the circumference of the accommodation space may be perpendicular to each other. In this manner, when the body member 110 of the sensor 100 for the battery assembly according to another embodiment of the present disclosure having the above-described aspect and at least a part of the battery assembly 200 are coupled to each other, the airtightness of the accommodation space 115 may be secured from the outside.

Referring again to FIGS. 6 and 7, in an embodiment, the sealing member 120 may correspond to the accommodation space 115.

In addition, the descriptions of the material of the body member 110 and/or the sealing member 120, the sensing member 130, the monitoring module 150, the connection line 140, and the controller module (not shown) described with reference to FIGS. 1 to 3 may be applied without limitation.

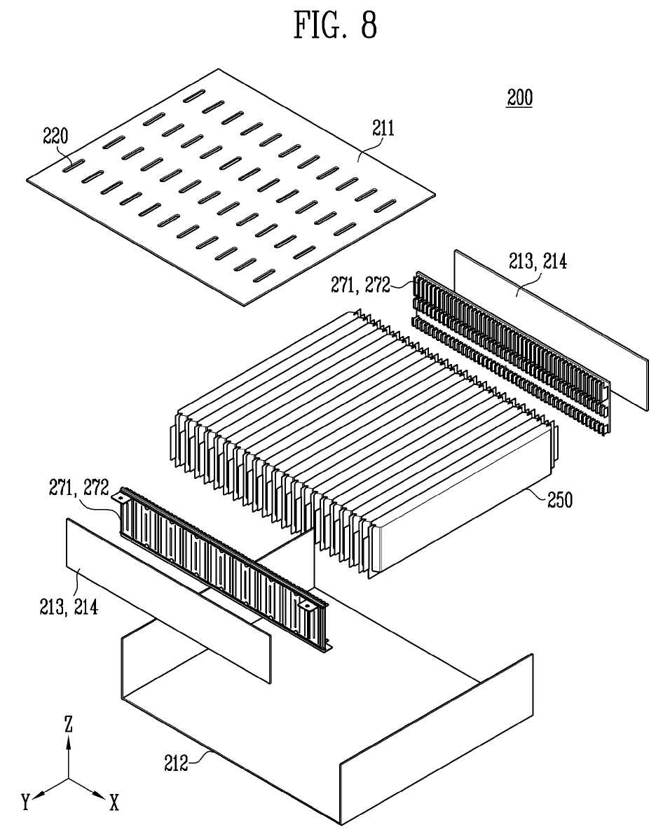

FIG. 8 is an exploded view showing an example of a battery assembly to be tested.

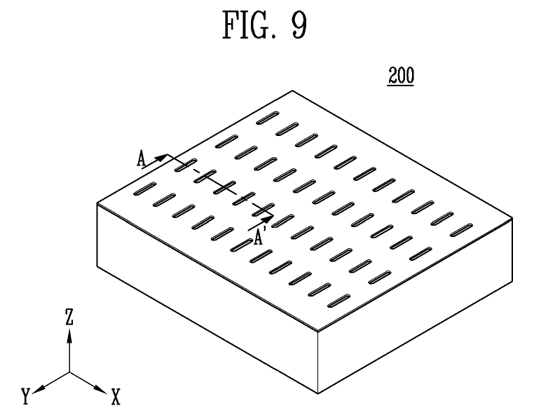

FIG. 9 is a diagram showing a combined state of the battery assembly 200 of FIG. 8.

In an embodiment, the battery assembly 200 may include a plurality of battery cells 250, a housing 210 for accommodating the battery cells 250, and a venting hole 220 formed in at least a portion of the housing 210.

In an embodiment, the battery cell 250 may include a cathode, an anode, a separator, and an electrolyte as main components. In an embodiment, the battery cell 250 may include an electrode assembly including a cathode, an anode, and a separator.

According to an exemplary embodiment, the cathode may include a cathode current collector and a cathode active material applied to at least one surface of the cathode current collector. The cathode current collector may include a known conductive material to the extent that the material does not cause a chemical reaction in a lithium secondary battery. The cathode current collector may include, for example, one of stainless steel, nickel (Ni), aluminum (AI), titanium (Ti), copper (Cu), and alloys thereof, and may be provided in various forms such as a film, a sheet, and foil. The cathode active material may include a material through which lithium ions may be inserted and extracted. The cathode active material may be, for example, a lithium metal oxide.

According to an exemplary embodiment, the anode may include an anode current collector and an anode active material applied to at least one surface of the anode current collector. The anode current collector may include a known conductive material to the extent that the material does not cause a chemical reaction in the lithium secondary battery. The anode current collector may include, for example, one of stainless steel, nickel (Ni), aluminum (AI), titanium (Ti), copper (Cu), and alloys thereof, and may be provided in various forms such as a film, a sheet, and foil. The anode active material may include a material through which lithium ions may be inserted and extracted. The anode active material may include, for example, a carbon-based material such as crystalline carbon, amorphous carbon, a carbon composite, or carbon fiber, a lithium alloy, or one or a combination of silicon (Si) and tin (Sn).

According to an exemplary embodiment, each of the cathode and the anode may further include a binder and a conductive material for improving mechanical stability and electrical conductivity.

According to an exemplary embodiment, the battery cell 250 may further include a separator to prevent electrical a short circuit between the cathode and the anode and generate a flow of ions. The separator may include, for example, a porous polymer film or a porous nonwoven fabric.

Therefore, according to the embodiment, the electrode assembly may have a structure in which a cathode, a separator, and an anode are stacked in a predetermined stacking direction. The cathode, the separator, and the anode may be stacked in a stacking, stack-folding or Z-stacking manner.

According to an exemplary embodiment, the battery cell 250 may include an electrolyte solution to immerse the electrode assembly. The electrolyte solution may be a non-aqueous electrolyte solution. The electrolyte solution may include a lithium salt and an organic solvent, and may further include an additive if necessary.

According to another exemplary embodiment, the battery cell 250 may further include a solid electrolyte layer including an electrolyte in a solid form. Therefore, according to the embodiment, the electrode assembly may have a structure in which a cathode, a solid electrolyte layer, and an anode are stacked in a predetermined stacking direction.

The battery cell 250 may include the above-described main components and a cell case accommodating these main components. The battery cell 250 may further include electrode leads. The electrode leads may be connected to the cathode and the anode, respectively. The electrode lead may protrude to the outside of the cell case to electrically connect the battery cell to the outside.

In one embodiment, the housing 210 may receive the plurality of battery cells 250. According to an exemplary embodiment, the housing 210 may accommodate the plurality of battery cells 250 as a single stack, and the battery assembly 200 may mean a battery module. Alternatively, the housing 210 may accommodate a plurality of battery modules in which the plurality of battery cells 250 are accommodated in a single stack, and the battery assembly 200 may mean a battery pack. Alternatively, the housing 210 may accommodate a plurality of stacks each including the plurality of battery cells 250 as one stack without a separate battery module structure, and the battery assembly 200 may refer to a cell-to-pack type battery pack. The housing 210 may form an interior space for accommodating the plurality of battery cells 250 and other components for driving the battery assembly 200.

Referring to FIG. 8, in an embodiment, the housing 210 may include an accommodating cover 211, an accommodating body 212, and end plates 213 and 214.

According to an exemplary embodiment, the accommodating cover 211 and the accommodating body 212 may be coupled to each other in the Z direction with reference to FIG. 8. The accommodating cover 211 may cover one surface of the stack of the plurality of battery cells 250, and may cover another surface of the stack in a direction opposite to a direction in which the accommodating cover 212 covers the stack.

According to an exemplary embodiment, the accommodating body 212 may be provided in a channel shape or a "U" shape with one side open. Referring to FIG. 8, the accommodating body 212 may be formed such that both sides facing each other in the Y direction are open.

In one embodiment, the end plates 213 and 214 may cover both sides of the accommodating body 212 facing each other in the Y direction. In one embodiment, the end plates 213 and 214 may prevent both sides of the stack of the plurality of battery cells 250 from being exposed to the outside.

In one embodiment, the venting hole 220 may be formed in at least a portion of the housing 210. The venting hole 220 may discharge venting gas generated in at least one of the plurality of battery cells 250 accommodated in the housing 210 to the outside.

Referring to FIGS. 8 and 9, in an embodiment, the venting hole 220 may be formed over the entire surface of one face of the housing 210. Referring to FIGS. 8 and 9, the venting hole 220 may be formed over the entire surface of the accommodating cover 211. However, the venting hole 220 may be formed on one surface of the housing 210, but may be formed only in a partial area of the one surface of the housing 210. That is, the venting hole 220 may be formed only in a partial area of the accommodation cover 211. The shape, number, and size of the venting holes 220 may be appropriately selected, and are not limited to those shown in the drawings of the present disclosure without departing from the scope defined in the present disclosure.

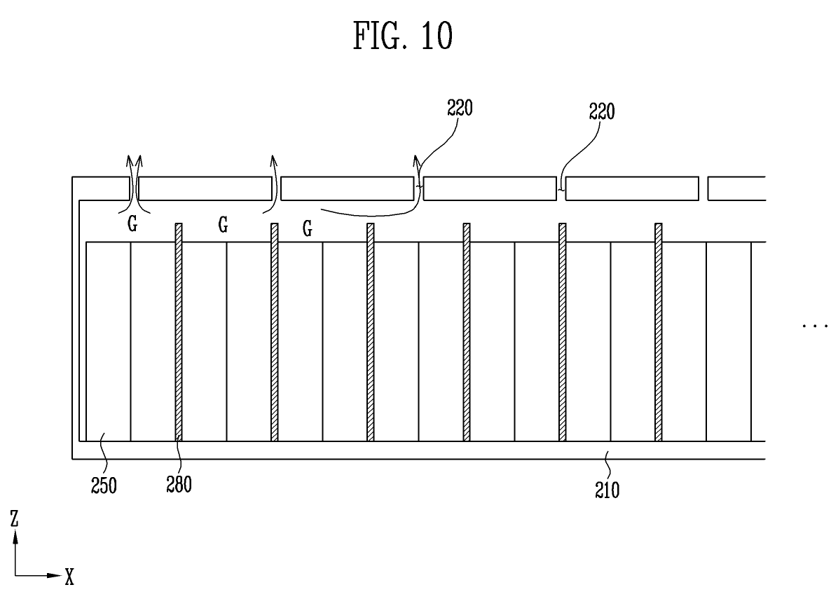

FIG. 10 is a cross-sectional view taken along line A-A' of FIG. 9.

FIG. 10 is a diagram schematically illustrating an internal structure of the battery assembly 200 as described with reference to FIGS. 8 and 9. Venting gas G generated in at least one of the battery cells 250 may be discharged to the outside through the venting hole 220. The venting gas G discharged to the outside through the venting hole 220 may have a specific gas composition such as carbon monoxide, carbon dioxide, methane, ethane, benzene, ethylene, or the like as described above, or may exhibit a temperature or humidity in a certain range.

In addition to the above-described components, the battery assembly 200 may further include a barrier 280 inserted between the battery cells 250 to block heat transfer between the battery cells or provide surface pressure, bus bars 271 and 272 for electrically connecting one or more of the components, and the like.

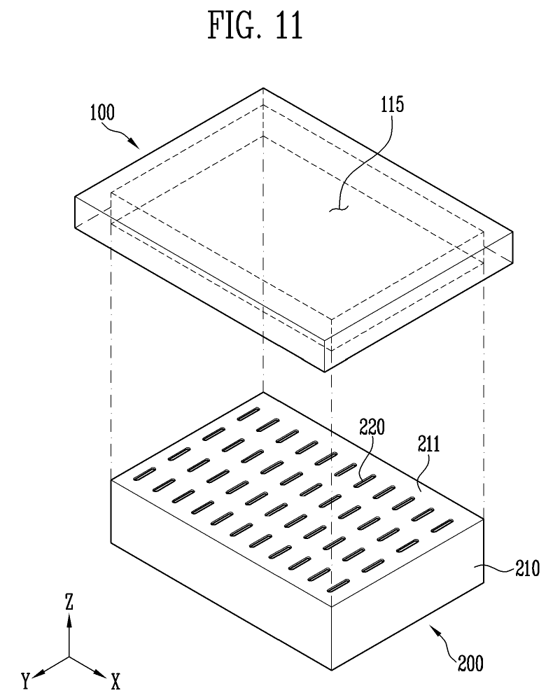

FIG. 11 is an exploded view illustrating the sensor 100 for the battery assembly and the battery assembly 200 to be tested according to an embodiment of the present disclosure.

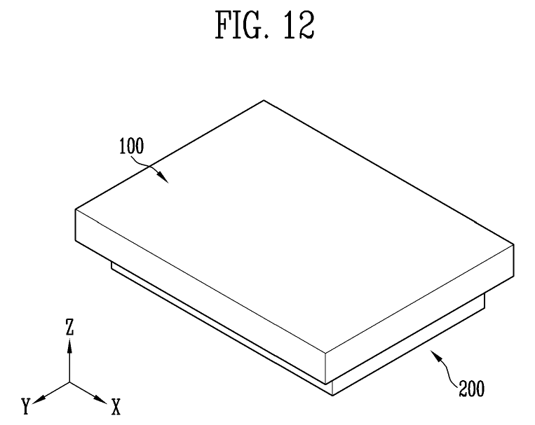

FIG. 12 is a diagram illustrating a state in which at least a part of the battery assembly 200 is accommodated in the sensor 100 for the battery assembly according to an embodiment of the present disclosure.

A battery assembly testing method according to an embodiment of the present disclosure is a method of testing the battery assembly 200 including the plurality of battery cells 250, the housing 210 accommodating the battery cells 250, and the venting hole 220 formed in at least a part of the housing 210 by using the sensor 100 for the battery assembly. The sensor 100 for the battery assembly includes the body member 110 having a first opening formed on one surface thereof and including the accommodation space 115 accommodating at least a portion of the battery assembly 200 through the first opening; the sealing member 120 disposed around the accommodation space 115; and the sensing member 130 coming in contact with the battery assembly 200 when at least a portion of the battery assembly 200 is accommodated in the accommodation space 105, formed in the accommodation space 115, and measuring environment data in the accommodation space 135. The test method may include: a process of accommodating at least a portion of the battery assembly 200 in the accommodation space 115; and a process of testing the battery assembly 200 accommodated in the accommodation space 115 by measuring or evaluating the environment data of the accommodation space 115.

In an embodiment, the accommodating process may refer to accommodating at least a part of the battery assembly 200 in the accommodation space 115.

In one embodiment, the accommodating process may include accommodating at least a portion of the battery assembly 200 such that the venting hole 220 may be located in the accommodation space 115.

By way of the example as shown in FIGS. 11 and 12, the battery assembly 200 to be tested may have the venting hole 220 formed over the entire surface of one face of the housing 210. As shown in FIGS. 8 and 9, the battery assembly 200 may be accommodated so that the venting hole 220 of the battery assembly 200 may be located in the accommodation space 115 by coupling the sensor 100 for the battery assembly and the battery assembly 200.

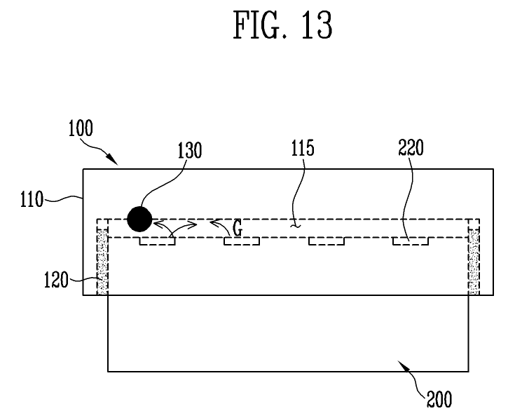

FIG. 13 is a diagram showing an inside of the battery assembly 200 accommodated in an accommodation space of the sensor 100 for the battery assembly according to an embodiment of the present disclosure.

In one embodiment, the accommodating process may include accommodating at least a portion of the battery assembly 200 such that the accommodation space 115 may be sealed from the outside.

Referring to FIG. 13, when the battery assembly 200 is accommodated in the accommodation space 115 of the sensor 100 for the battery assembly, the area where the sensor 100 and the assembly 200 are coupled to each other is sealed by the sealing member 120 as described above to accommodate at least a part of the battery assembly 200 so that the accommodation space 115 may be sealed from the outside.

As described above, to couple the body member 110 and the battery assembly 200 to each other, the accommodation space 115 of the body member 110 and at least a part of the battery assembly 200 may correspond to each other with a slight separation space. As shown in FIG. 13, the separation space is sealed by the sealing member 120, so that the accommodation space 115 may be surrounded by the body member 110, the sealing member 120, and the battery assembly 200, and ultimately, may be sealed from the outside.

In an embodiment, the testing process may refer to a process of testing the battery assembly 200 accommodated in the accommodation space 115 by measuring or evaluating the environment data of the accommodation space 115.

In an embodiment, the environment data may include the presence or amount of the venting gas G discharged from the venting hole 220.

As described above, the sensor 100 and the battery assembly 200 may be coupled to each other such that the venting hole 220 may be located in the accommodation space 115, so that the accommodation space 115 may be sealed from the outside as described above. Accordingly, both the sensing member 130 and the venting hole 220 formed in the accommodation space 115 may be located in the accommodation space 116 which is sealed as described above. Therefore, the accommodation space 115 may be maintained in a state in which external air is not mixed therein. When the venting gas G is generated from at least one of the plurality of battery cells 250, only the venting gas G flowing through the accommodation space 115 may be measured in the state in which there is substantially no external air mixed therein, so that the occurrence or non-occurrence of the venting gas G and the generation amount thereof may be quickly measured with considerably high accuracy.

In an embodiment, the method of testing the battery assembly 200 may further include a process of collecting and storing data measured and evaluated from the testing process. As described above, the sensor 100 for the battery assembly may include the monitoring module 150 and the controller module (not shown), and may be used not only to measure the occurrence and generation of venting gas, but also to collect and store the obtained data for use and analysis in other test processes.

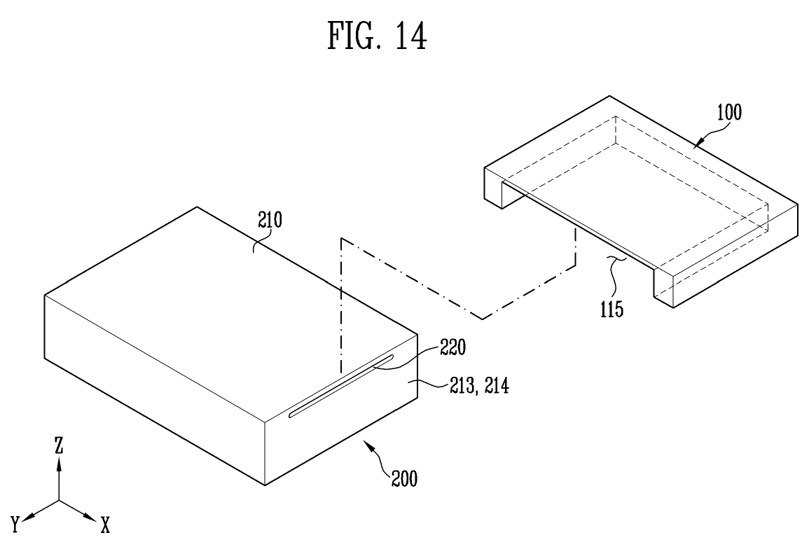

FIG. 14 is an exploded view illustrating the sensor 100 for the battery assembly and the battery assembly 200 to be tested according to another embodiment of the present disclosure.

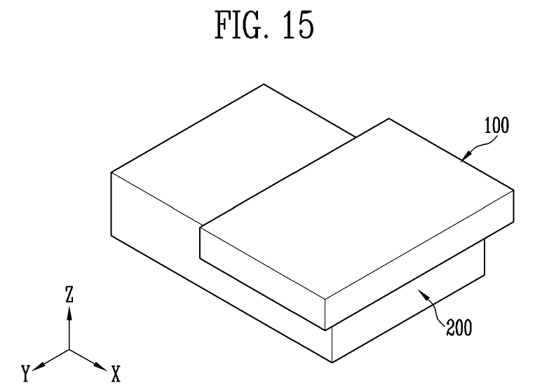

FIG. 15 is a diagram illustrating a state in which at least a part of the battery assembly 200 is accommodated in the sensor 100 for the battery assembly according to another embodiment of the present disclosure.

FIGS. 14 and 15 are diagrams showing that the battery assembly 200 to be tested is accommodated in the sensor 100 for the battery assembly according to another embodiment of the present disclosure.

By way of an example shown in FIGS. 14 and 15, in the battery assembly 200 to be tested, the venting hole 220 may be formed in a partial area of one surface of the housing 210.

Referring to FIGS. 8 and 9, the venting hole 220 may be formed over a portion of the end plates 213 and 214. More specifically, the venting hole 220 may extend in an extension direction of an edge in an adjacent region of at least one of the edges of the housing 210. That is, the venting hole 220 may be formed on the end plates 213 and 214 extending in the extension direction of the edge over the area adjacent to the accommodating cover 211. Alternatively, the end plates 213 and 214 may extend in the extension direction of each edge over each area adjacent to the accommodating body 212. As shown in FIGS. 14 and 15, the battery assembly 200 may be accommodated so that the venting hole 220 of the battery assembly 200 is located in the accommodation space 115 by coupling the sensor 100 for the battery assembly to the battery assembly 200.

When the battery assembly 200 is accommodated in the accommodation space 115 of the sensor 100 for the battery assembly as described above, the accommodation space 115 may be sealed from the outside. As described above with reference to FIGS. 11 to 13, the descriptions related to accommodating the battery assembly 200 to seal the accommodation space 115 are the same as those as above. Thus, overlapping descriptions will be omitted below.

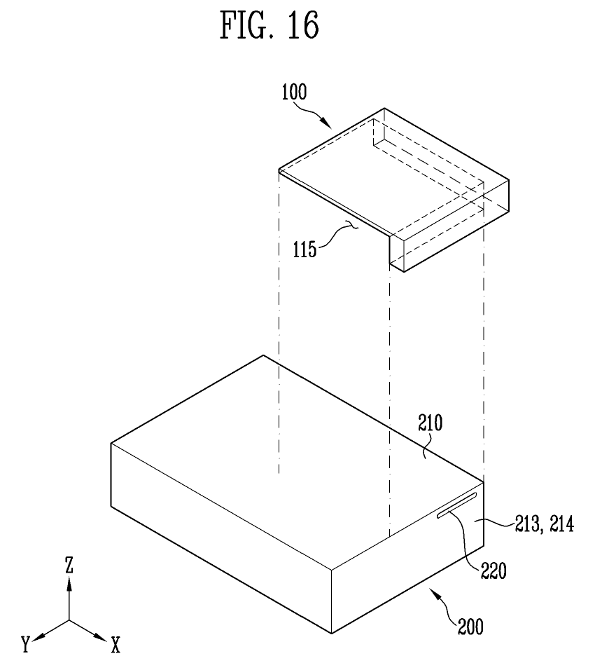

FIG. 16 is an exploded view illustrating the sensor 100 for the battery assembly and the battery assembly 200 to be tested according to another embodiment of the present disclosure.

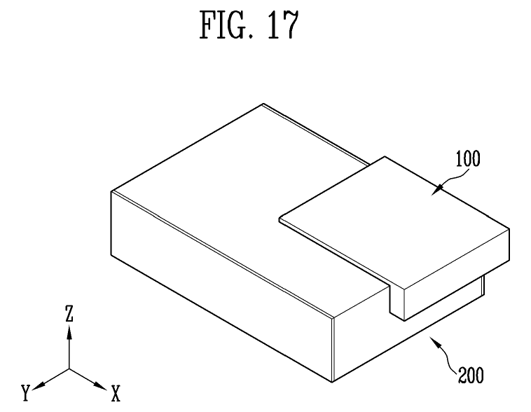

FIG. 17 is a diagram illustrating a state in which at least a part of the battery assembly 200 is accommodated in the sensor 100 for the battery assembly according to another embodiment of the present disclosure.

FIGS. 16 and 17 are diagrams illustrating accommodating the battery assembly 200 to be tested in the sensor 100 for the battery assembly according to another embodiment of the present disclosure.

By way of the example as shown in FIGS. 16 and 17, the battery assembly 200 to be tested may include the venting hole 220 which is formed in a partial area of one surface of the housing 210. Referring to FIGS. 8 and 9, the venting hole 220 may be formed over a portion of the end plates 213 and 214. More specifically, the venting hole 220 may be formed in an area adjacent to at least one of the respective vertices of the housing 210. That is, the venting hole 220 may be formed on the end plates 213 and 214 in a region adjacent from at least one of the respective vertices of the housing 210. As shown in FIGS. 16 and 17, by coupling the sensor 100 for the battery assembly and the battery assembly 200, the battery assembly 200 may be accommodated so that the venting hole 220 of the battery assembly 200 may be located in the accommodation space 115.

When the battery assembly 200 is accommodated in the accommodation space 115 of the sensor 100 for the battery assembly as described above, the accommodation space 115 may be sealed from the outside. As described above with reference to FIGS. 11 to 13, the descriptions related to accommodating the battery assembly 200 to seal the accommodation space 115 are the same as above, and therefore, overlapping descriptions will be omitted below.

A method of testing a battery assembly according to an embodiment of the present disclosure may easily, quickly, and accurately check whether venting gas is generated in a battery cell without creating testing environment as vacuum environment, and may easily adjust other variables (temperature, etc.) of the testing environment while checking whether the venting gas is generated, so that the battery may be tested more efficiently.

According to an aspect of the present disclosure, a sensor for a battery assembly that has a simple structure and can quickly and accurately measure whether venting gas is generated in a battery to be evaluated may be provided.

According to another aspect of the present disclosure, a testing method of a battery assembly that can quickly and accurately measure whether venting gas is generated in a battery to be evaluated without adjusting evaluation environment to a vacuum state, and can easily adjust variables such as temperature while evaluating whether the venting gas is generated.

Meanwhile, the present disclosure may be widely applied in the fields of electric vehicles, battery charging stations, energy storage systems (ESS), and other green technologies such as photovoltaics and wind power using batteries. In addition, the present disclosure may be used in eco-friendly mobility, including electric vehicles and hybrid vehicles, to prevent climate change by suppressing air pollution and greenhouse fluid emissions.

The present disclosure may be modified and implemented in various forms, and its scope is not limited to the above-described embodiments. The content described above is merely an example of applying the principles of the present disclosure, and otherfeatures may be further included without departing from the scope of embodiments according to the present disclosure.

What is claimed is:

1. A sensor for a battery assembly, comprising:
a body member having a first opening formed on one surface of the body member, the body member including an accommodation space accommodating at least a part of the battery assembly through the first opening;
a sealing member disposed around the accommodation space, the sealing member coming in contact with the battery assembly when at least the part of the battery assembly is accommodated in the accommodation space; and
a sensing member formed in the accommodation space and measuring environment data in the accommodation space.

2. The sensor for the battery assembly according to claim 1, wherein the body member and the sealing member include materials having different hardnesses.

3. The sensor for the battery assembly according to claim 1, wherein the body member includes a hard material.

4. The sensor for the battery assembly according to claim 3, wherein the body member includes a transparent material.

5. The sensor for the battery assembly according to claim 1, wherein the sealing member includes a soft material.

6. The sensor for the battery assembly according to claim 1, wherein the body member and the sealing member include a material through which air or water does not permeate.

7. The sensor for the battery assembly according to claim 1, further comprising a monitoring module electrically connected to the sensing member and monitoring the environment data measured from the sensing member.

8. The sensor for the battery assembly according to claim 7, further comprising a connection line electrically connecting the sensing member and the monitoring module, wherein the connection line comprises a first connection line having a variable position and a second connection line having a fixed position, and at least one end of the first connection line is connected to the sensing member.

9. The sensor for the battery assembly according to claim 7, further comprising a controller module electrically connected to the monitoring module, controlling the sensing member, and collecting and storing the environment data.

10. The sensor for the battery assembly according to claim 1, wherein the body member is formed such that the accommodation space further includes an opening on at least one other surface perpendicular to the one surface.

11. A testing method of a battery assembly including a plurality of battery cells, a housing accommodating the plurality of battery cells, and a venting hole formed in at least a part of the housing by using a sensor for the battery assembly, the sensor for the battery assembly comprising:
a body member having a first opening formed on one surface of the body member,
the body member including an accommodation space accommodating at least a portion of the battery assembly through the first opening; a sealing member disposed around the accommodation space, the sealing member coming in contact with the battery assembly when at least a part of the battery assembly is accommodated in the accommodation space; and
a sensing member formed in the accommodation space and measuring environment data in the accommodation space, the testing method comprising:
accommodating at least the part of the battery assembly in the accommodation space; and
testing the battery assembly accommodated in the accommodation space by measuring or evaluating the environment data of the accommodation space.

12. The testing method according to claim 11, wherein the accommodating comprises accommodating at least the part of the battery assembly such that the venting hole is located in the accommodation space.

13. The testing method according to claim 12, wherein the accommodating comprises accommodating at least the part of the battery assembly so that the accommodation space is sealed from an outside.

14. The testing method according to claim 11, wherein the environment data includes presence or amount of venting gas discharged from the venting hole.

15. The testing method according to claim 11, further comprising collecting and storing data measured or evaluated by the testing.
